(19) United States
(12) Patent Application Publication
(10) Pub. No.: US 2024/0381172 A1
(43) Pub. Date: Nov. 14, 2024

(54) CONTROL APPARATUS AND METHOD FOR CONTROLLING DATA TRAFFIC IN A VEHICLE, AND VEHICLE SYSTEM

(71) Applicant: Robert Bosch GmbH, Stuttgart (DE)

(72) Inventors: Philip Wette, Bueckeburg (DE); Johannes Morgenroth, Hildesheim (DE)

(21) Appl. No.: 18/688,972

(22) PCT Filed: Jul. 8, 2022
(86) PCT No.: PCT/EP2022/069073

§ 371 Date: Mar. 29, 2024

(30) Foreign Application Priority Data
Sep. 7, 2021 (DE) 10 2021 209 844.4

(51) Int. Cl. H04W 28/02; H04W 28/26; H04W 88/02

(52) U.S. Cl. CPC H04W 28/0289; H04W 28/0226; H04W 28/26; H04W 88/02

(57) ABSTRACT

A control apparatus for controlling data traffic, which is generated by functional units of a vehicle, via a radio device includes a functional interface for connecting the control apparatus to functional units and for reading in requirement signals representing requirements of the functional units in terms of a capacity required in the future for the data traffic for transmitting functional data. The control apparatus also comprises a transmission interface for connecting the control apparatus to the radio device and a determination device which is designed to use a route signal, a network signal, and the requirement signals, in order to determine capacity signals representing partial capacities available in the future for the functional units.

### FIELD

The present invention is based on a control apparatus and a method for controlling data traffic of a vehicle along with a vehicle system.

### BACKGROUND INFORMATION

Various software functions can be distributed in a vehicle, which software functions can be executed during travel and can for this define specific requirements for communication with remote terminals outside the vehicle. If the current driving situation of the vehicle changes, a reallocation of the available network resources to different vehicle sensors may be necessary.

### SUMMARY

The present invention provides an improved control apparatus and an improved method for controlling data traffic of a vehicle along with an improved vehicle system according to the main claims. Advantageous embodiments, developments, and improvements of the device disclosed herein are possible by the measures set out in the disclosure herein.

By means of the control apparatus presented here, compliance with the communication requirements of the software components running in a vehicle can be optimized. This prevents overload situations and conserves vehicle and mobile radio resources. Furthermore, targeted influence can be exerted on resource allocation in order to prioritize important functions and prevent starvation of individual applications. Starvation can be understood to mean that an individual application is no longer used at all due to prioritization and has thus been effectively deactivated.

A control apparatus for controlling data traffic generated by functional units of a vehicle via a radio device of the vehicle is presented. The control apparatus according to an example embodiment of the present invention comprises a functional interface for connecting the control apparatus to a first functional unit and to a second functional unit and for reading in a first requirement signal representing a first requirement of the first functional unit in terms of a capacity required in the future for the data traffic for transmitting first functional data, and a second requirement signal representing a second requirement of the second functional unit in terms of a capacity required in the future for the data traffic for transmitting second functional data. The control apparatus also has a transmission interface for connecting the control apparatus to the radio device. Furthermore, the control apparatus comprises a determination device which is designed to use a network signal, which represents a size of a maximum capacity for the data traffic along a probable future route of the vehicle and dependent on a radio network coverage, to determine a first capacity signal of the first requirement signal and the second requirement signal, which represents a first partial capacity available in the future for the first functional unit, and to determine a second capacity signal representing a second partial capacity available in the future for the second functional unit, in order to enable the functional units to adjust the capacities required in the future to the partial capacities available in the future.

Optionally, according to an example embodiment of the present invention, the control apparatus can be designed to use a route signal representing the probable future route of the vehicle in order to determine the capacity signals. The ascertainment of a channel capacity can thus be effected with or without a route signal, for example directly from a “short-term prediction” or directly by the mobile radio operator.

For example, software distributed within vehicle systems can be executed, with its functional units defining various requirements for communication with remote terminals outside the vehicle, such as, for example, data rate, latencies, maximum jitter, acceptable packet loss rate, etc. These requirements can subsequently be captured at a central location in the vehicle and used to distribute the communication resources available to the vehicle, such as, for example, communication via one or more radio networks, for example LTE mobile radio networks or WLAN networks, to the individual software components in such a way that the individual requirements of all components as a whole can be served in the best possible way. The specified capacity can be a transmission capacity of a transmission channel via which the data traffic is sent. Examples of requirements made by a software component can be, for example:

A file download from the URL www.meine.url/datei.zip will start in 5 seconds. The file size is 50 MB. This download must be completed within 300 seconds at the latest.

The video stream from 10.0.1.2:17236 to 1.2.3.4:5000 requires a latency of less than 100 ms. It is a stream with a constant data rate that is transmitted either at 3 Mbit/s (high quality) or at 1 Mbit/s (low quality).

However, the requirements can also be far more complex. If the route the vehicle is most likely to take is known, for example, because navigation to a specific destination is active or the most probable path (MPP) has been learned, it can additionally be estimated at any point in time in the future what properties, such as maximum data rate, packet loss rate, latency, jitter, etc., radio transmission to or from the vehicle may possess. With this estimate, together with the communication requirements set by the components, it is not only possible to carry out an optimal distribution of communication resources to the individual functional units, it is also possible to ascertain whether and when the requirements can probably be fulfilled. This information can subsequently be passed back to the functional units, so that they can know in advance when their requirements need to be adjusted or when they can expect which communication properties. The functional units can thus advantageously initiate measures at an early stage in order to continue operating correctly. Without such optimal distribution, the system performance could move away from the optimal operating point. In concrete terms, this means that either the available capacity may not be fully utilized even though the system would be able to achieve better performance, or an overload could be generated at the bottleneck, typically the mobile radio modem. The latter would be particularly fatal. This is because overloading the data rate could have a negative impact on other channel properties such as, for example, latency, jitter and packet loss. With the control apparatus presented here, such packet losses can be advantageously minimized or entirely avoided. In addition, by using the method described, the central component, which calculates the optimal distribution of communication resources, can be enabled by the proposed method to control and positively influence the so-called quality of service for all functions performed in the vehicle and even to prioritize individual data streams. This can be done, for example, using a weighting function, which can change dynamically depending on time or user requirements. Due to the technical proximity to mobile radio technologies, a realization on a connectivity control unit (CCU) is suitable for such a control apparatus.

According to one example embodiment of the present invention, the determination device can be designed to calculate an allocation of the partial capacities for the data traffic to the functional units and to provide the capacity signals to the functional units via the functional interface. For example, the determination unit can use the requirement signals and the route signal to calculate the capacitive power that can be available for the individual functional units during a future section of the route of the vehicle. Advantageously, this can reduce the overall load on the control apparatus. If the applications know in advance when and how much data they are allowed to transmit, for example, buffers can be smaller. In addition, the execution of potentially CPU-intensive QoS algorithms for classifying and prioritizing traffic can be reduced or avoided altogether. In addition, the so-called buffer bloat problem in long-distance networks can be countered by allocating partial capacities available in the future. Buffer bloat refers to the phenomenon whereby packets accumulate at an internet router. So-called buffers fill up until the router finally has no choice but to discard packets. In mild cases, this simply increases communication latency. However, in most cases it does not stop there, and packet loss inevitably occurs. This problem can arise whenever more data arrives at a router than it can send out. This effect can already occur within the vehicle. Incoming can be the mobile radio base of the router. Outgoing can be the CCU or the modem contained within it, and all devices connected thereto can produce data packets in a poorly predictable pattern. In order to prevent an overload and thus keep properties such as latency and packet loss constant, the control apparatus presented here can already take into account the respective amount when generating the data packets.

According to a further example embodiment of the present invention, the determination device can be designed to read in the route signal via the functional interface. For example, the control apparatus can be connected to a navigation device for navigating the vehicle via the function interface. The navigation device can be designed to calculate a current route for the vehicle to a specific destination and provide it in the form of the route signal. Additionally or alternatively, a most probable path (MPP) may have been learned. Advantageously, the determination device can determine the future route of the vehicle at an early stage by means of the route signal and adjust the generated data traffic accordingly.

According to a further embodiment of the present invention, the determination device can be designed to read in, via the transmission interface, the network signal, which represents a size of a maximum capacity for the data traffic along the route and depends on a radio network coverage. For example, the network signal can be provided via the radio device connected to the control apparatus. The radio device can be designed to detect radio network coverage along the route and provide it to the determination device using the network signal. Advantageously, this makes it possible to optimally calculate the point in time at which a specific size of capacity can be available for the data traffic for the functional units of the vehicle.

According to a further embodiment of the present invention, the determination device can comprise an optimization device, which can be designed to use the route signal, the network signal, the first requirement signal and the second requirement signal to calculate the first partial capacity and the second partial capacity and to assign the partial capacities to the functional units. For example, the optimization device, which can also be referred to as an optimizer, can receive data on what properties (data rate, latency, etc.) the radio connection will have in the future. This can be achieved, for example, by combining a calculated MPP (most probable path) and a mobile radio coverage map. In addition, the optimizer can receive all the requirements of the software components for their data flows. On this basis, the optimization device can calculate how and when the available resources are allocated to the different data flows. This allocation can be calculated, for example, by optimizing a target function. This target function can, for example, link to one another, weight and prioritize the different requirements. This target function can be selected arbitrarily by the optimizer and can also change over time in order to be able to express the changing importance and urgency of individual functions.

The allocation of resources to data streams can be calculated in different ways using the target function. For example, a rigorous mathematical description and subsequent optimal solution by means of linear programming can be used. In addition, heuristics or approximations can also be drawn on for the calculation. Advantageously, the control apparatus can be optimally designed using an optimization device.

In addition, according to an example embodiment of the present invention, the optimization device can be designed to compare the route with a mobile radio coverage map provided by means of the transmission interface and depicting the radio network coverage, in order to determine a temporal progression of the size of the future maximum capacity for the data traffic. The mobile radio coverage map can, for example, be a cloud service that provides predictions of expected connection properties at a location at a specific time. With the help of the most probable path (MPP), the expected connection properties, such as maximum data rate, packet loss rate, latency, jitter, etc., along the path of the vehicle, can be queried at any point in time in the future. Instead of or in addition to a mobile radio coverage map, methods such as predictive quality of service (pQoS) or local short-term prediction can also be used for the communication channel.

According to a further embodiment of the present invention, the determination device can comprise a forecasting device, which can be designed to provide the first and second capacity signals. The forecasting device, which can also be referred to as a forecast, can, for example, receive the calculated result of the optimizer and distribute it to those functional units that have placed requirements. These functional units can advantageously deduce the time at which an adjustment of their own data flows is necessary in order to achieve optimal performance.

According to a further embodiment of the present invention, the determination device can be designed to read in, via the functional interface, a first functional signal comprising the first functional data and a second functional signal comprising the second functional data and to provide them to the transmission interface.

According to a further embodiment of the present invention, the determination device can comprise a traffic shaping device, which can be designed to use the first capacity signal to output the first functional data and use the second capacity signal to output the second functional data via the transmission interface. The traffic shaping device can also be referred to as traffic shaping or queue management. Traffic shaping can receive information regarding how the individual data flows are to be handled by the optimizer. The traffic shaping device can be designed to shape the data flows according to a calculated schedule. For example, if there is so-called legacy software in the vehicle that has not placed any requirements on the determination device, it can be assumed that this software has a lower priority than the software that has placed requirements. As a result, the legacy software can only use the remaining communication resources that are left over after this process. This is achieved through the process of traffic shaping. Advantageously, by using the traffic shaping device, the generated data traffic can be shaped according to a currently available capacity.

According to a further embodiment of the present invention, the first requirement and additionally or alternatively the second requirement can comprise a utility function, wherein the utility function describes the utility of specific properties of the data traffic. For example, the requirements of the functional units can be expressed in the form of utility functions via communication properties. The utility functions provided by the respective functional unit can be multidimensional, for example. The dimensions used and their number can be arbitrary. The utility functions can be used to map the utilities experienced by the functional unit from the communication. The functional units can, for example, proactively communicate their requirements for future communication properties in the form of utility functions not only to the CCUs installed in the vehicle but also to the other software applications run in the vehicle. Utility functions can change over time. This means, for example, that an application can have a utility function for a time period t₀-t₁ different from that for a time period t₁-t₂. For example, an application X may require map data for its execution. Such map data can be stored on an external server in two qualities: high and low. The card M^{Hi} with high quality can have a large file size s^{Hi}, but allow X to operate in full functionality. The card M^{Lo} with low quality can have a small file size s^{Lo}, but only allow X a limited functionality. The download of the map should be completed at a point in time t+δt, since X requires the data then. In order to load M^{Hi} by then, an average data rate of s^{Hi}/δt may be required for application X in the next δt seconds. In order to load M^{Lo} by then, an average data rate of s^{Lo}/δt may be required for application X in the next δt seconds. This can be included in the utility function for application X. After optimization, a decision can be made as to whether to load either M^{Hi} or M^{Lo} with the allocated resources, since X now has information available as to what data rate will be achieved in the future. Due to the fact that the control apparatus is provided with the corresponding utility functions of all participating applications, it can advantageously calculate highly optimized distributions of communication resources without needing to know the applications themselves.

According to a further embodiment of the present invention, the utility function can be determinable using an allocation plan. For example, as soon as a plurality of functional units in the sense of a distributed system offer a service whose quality can depend on the utility of its individual components, the, for example, manual definition of the corresponding utility functions can be highly time-consuming. For this reason, it is also possible to generate such dependent utility functions from an allocation plan. An allocation plan for a distributed system can specify how resources are to be distributed to individual data streams so that the distributed system can provide a certain utility as a whole. A utility function can now also be defined for an allocation plan, which utility function in turn can specify the utility of the distributed system. Advantageously, utility functions can be generated in a time-saving manner.

According to a further embodiment of the present invention, the first requirement and additionally or alternatively the second requirement can comprise an expiration period for defining an end point in time of the transmission of functional data. For example, a requirement of a functional unit can be that a software download or software upload be completed by a specific point in time. Using such an expiration period or deadline, by means of the determination device an optimal prioritization for the allocation of partial capacities to the individual functional units can advantageously be carried out.

In addition, a vehicle system that has a variant of the previously presented control apparatus is presented. In addition, according to an example embodiment of the present invention, the vehicle system comprises a plurality of functional units, which are designed to provide requirement signals representing the requirements of the functional units in terms of a capacity required in the future for the data traffic for transmitting functional data, to receive capacity signals representing partial capacities available in the future for the functional units, and to provide functional signals representing the functional data. Furthermore, the vehicle system comprises a radio device that has at least one communication means for transmitting and receiving data via a radio network, a radio interface for connecting the communication means to the radio network, and a transmission interface for connecting the radio device to the control apparatus, wherein the radio device is designed to read in functional signals via the transmission interface. In such a vehicle system, all of the aforementioned advantages of the control apparatus can be optimally implemented.

A communication means can be understood to be an interface, such as, for example, an LTE modem. The radio network can be understood to be a mobile radio network or a WLAN network, for example.

In addition, a method for controlling data traffic generated by functional units of a vehicle via a radio device of the vehicle is presented. For example, according to an example embodiment of the present invention, the method can be carried out using a variant of the control apparatus presented above. The method comprises a step of reading in a first requirement signal and a second requirement signal via a functional interface to a first functional unit and a second functional unit, wherein the first requirement signal represents a first requirement of the first functional unit in terms of a capacity required in the future for the data traffic for transmitting first functional data and the second requirement signal represents a second requirement of the second functional unit in terms of a capacity required in the future for the data traffic for transmitting second functional data. According to an example embodiment of the present invention, the method further comprises a step of determining a first capacity signal and a second capacity signal using optionally a route signal representing a probable future route of the vehicle, a network signal representing a size of a maximum capacity for the data traffic existing along the route and dependent on a radio network coverage, the first requirement signal and the second requirement signal, wherein the first capacity signal represents a first partial capacity available in the future for the first functional unit, and wherein the second capacity signal represents a second partial capacity available in the future for the second functional unit, in order to make it possible for the functional units to adjust the capacities required in the future to the partial capacities available in the future. Advantageously, by using the method presented, the central component, which calculates the optimal distribution of communication resources, is enabled by the proposed method to control and positively influence the quality of service for all functions carried out in the vehicle and even to prioritize individual data streams.

According to an example embodiment of the present invention, this method can be implemented, for example, in software or hardware or in a mixed form of software and hardware, for example in a control device.

A computer program product or a computer program having program code that can be stored on a machine-readable carrier or storage medium, such as a semiconductor memory, a hard disk memory, or an optical memory, and that is used for carrying out, implementing, and/or controlling the steps of the method according to one of the embodiments of the present invention disclosed herein is advantageous as well, in particular when the program product or program is executed on a computer or a device.

Exemplary embodiments of the present invention are illustrated in the figures and explained in more detail in the following description.

### BRIEF DESCRIPTION OF THE DRAWINGS

FIG. 1 shows a block diagram of a control apparatus according to an exemplary embodiment of the present invention.

FIG. 2 shows a block diagram of a vehicle system according to an exemplary embodiment of the present invention.

FIG. 3 shows a diagram of an exemplary embodiment of a utility function of the present invention.

FIG. 4 shows a diagram of an exemplary embodiment of a multidimensional utility function of the present invention.

FIG. 5 shows a diagram of an exemplary embodiment of a further multidimensional utility function of the present invention.

FIG. 6 shows a diagram of an allocation plan according to an exemplary embodiment of the present invention.

FIG. 7 shows a diagram of another utility function according to an exemplary embodiment of the present invention.

FIG. 8 shows a diagram of an exemplary embodiment of a utility function of the present invention.

FIG. 9 shows a flow chart of a method for controlling data traffic generated by functional units of a vehicle according to an exemplary embodiment of the present invention.

FIG. 10 shows a flow chart of an exemplary embodiment of a step of the method for controlling data traffic according to the peesent invention.

FIG. 11 shows a flow chart of an exemplary embodiment of a step of the method for controlling data traffic according to the present invention.

### DETAILED DESCRIPTION OF EXAMPLE EMBODIMENTS

In the following description of advantageous exemplary embodiments of the present invention, the same or similar reference signs are used for the elements shown in the various figures and acting similarly, as a result of which a repeated description of these elements is omitted.

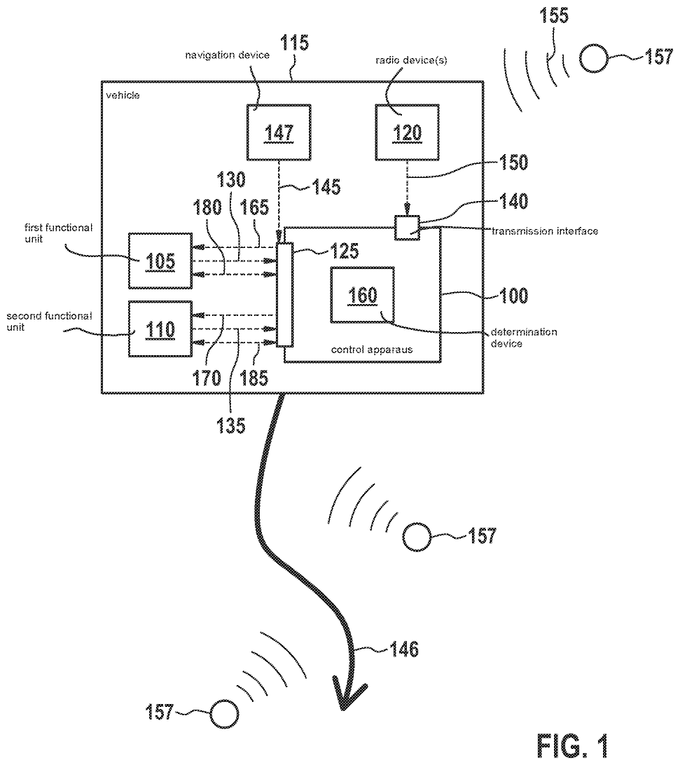

FIG. 1 shows a block diagram of a control apparatus 100 according to an exemplary embodiment. The control apparatus 100 is designed to control data traffic generated by functional units 105, 110 of a vehicle 115 via at least one radio device 120 of the vehicle 115. In this exemplary embodiment, the vehicle 115 is designed as an automated driving vehicle or an automatically driving vehicle controllable by a driver who is located outside the vehicle 115. Alternatively, the vehicle 115 can be a non-automated or only partially automated driving vehicle. With an automated or automatically driving vehicle, compliance with various communication requirements of the software component of the vehicle 115 is particularly relevant in order to avoid overload situations in data traffic and to conserve vehicle and mobile radio resources.

By means of the control apparatus 100, a targeted influence on resource allocation is possible in order to prioritize important functions and prevent individual applications from starving. For this purpose, the control apparatus 100 comprises a functional interface 125 for connecting the control apparatus 100 to a first functional unit 105 and to a second functional unit 110. The functional units 105, 110, which can also be referred to as software functions or software modules, are designed in this exemplary embodiment to communicate with communication partners outside the vehicle by means of the control apparatus 100. In order to communicate the requirements of the functional units 105, 110 for such communication, a first requirement signal 130 can be read in via the functional interface 125, which represents a first requirement of the first functional unit 105 in terms of a capacity required in the future for the data traffic for transmitting first functional data. Similarly, a second requirement signal 135 can be read in, which represents a second requirement of the second functional unit 110 in terms of a capacity required in the future for the data traffic for transmitting second functional data. Solely by way of example, the first requirement is a video stream that can be transmitted to the driver outside the vehicle 115 in order to enable so-called tele-operated driving. In this exemplary embodiment, the second requirement is the reloading of highly up-to-date map sections that are required for automatic driving. The second requirement comprises, solely by way of example, an expiration period for defining an end point in time for the transfer of functional data. This expiration period, which can also be referred to as a deadline, indicates in this exemplary embodiment that loading of the card data must have been completed at a specific point in time.

In another exemplary embodiment, the control apparatus can also be used, for example, to control the monitoring of automatically driven vehicles or to regulate further external intervention options, in order to optimally control the vehicle from a distance. This requires a reliable mobile radio-based function in order to issue the appropriate command to the vehicle 115.

Accordingly, the control apparatus 100 has a transmission interface 140 for connecting the control apparatus 100 to the at least one radio device 120. By means of the at least one radio device 120, communication with external participants via a radio network is enabled.

In addition, since the probable course of the travel path is also important for the optimal control of the vehicle 115, the control apparatus 100 is designed in one exemplary embodiment to read in a route signal 145 via the functional interface 125, which represents a probable future route 146 of the vehicle 115. For this purpose, the control apparatus 100 is connected, solely by way of example, via the functional interface 125 to a navigation device 147, which is designed to calculate the probable route 146 of the vehicle 115 to a specific destination by means of map data stored in the navigation device 147. In another exemplary embodiment, a most probable path (MPP) may also have been learned.

At the same time, the control apparatus 100 in this exemplary embodiment is designed to read in a network signal 150 via the radio interface 140, wherein the network signal 150 represents a size of a maximum capacity for the data traffic along the route 146 and dependent on a radio network coverage. Here, the radio device 120 receives a radio signal 155 by means of radio masts 157 arranged along the route 146. Since therefore the probable route 146 of the vehicle 115 is known, using the network signal 150 an estimation of properties, such as maximum data rate, packet loss rate, latency or jitter that a radio transmission from or to the vehicle 115 will have at any point in time in the future, is thus possible.

The control apparatus 100 is accordingly designed to use the route signal 145, the network signal 150, the first requirement signal 130 and the second requirement signal 135 to determine, by means of a determination device 160, a first capacity signal 165 and a second capacity signal 170. The first capacity signal 165 represents a first partial capacity available in the future for the first functional unit 105 and the second capacity signal 170 represents a second partial capacity available in the future for the second functional unit 110. According to an exemplary embodiment, the control apparatus 100 is designed to determine the capacity signals without using the route signal 145.

In this exemplary embodiment, the determination device 160 is designed to calculate an allocation of the partial capacities for the data traffic to the functional units 105, 110 and to provide the capacity signals 165, 170 to the functional units 105, 110 via the functional interface 125. In other words, the determination unit 160 is designed to communicate to the functional units 105, 110 if and when their communication requirements will be met in the future, so that they can proactively adjust their behavior accordingly. This makes it possible to predict at an early stage when functions in the vehicle 115 that depend on communication with external subscribers will no longer be available and makes it possible for the functional units 105, 110 to adjust the capacities required in the future to the partial capacities available in the future.

Following such an adjustment, the functional units 105, 110 in this exemplary embodiment are designed to provide a first functional signal 180 comprising the first functional data and a second functional signal 185 comprising the second functional data. The control apparatus 100 is designed to read in these functional signals 180, 185 via the functional interface 125 and provide them to the transmission interface 140.

The two functional units 105, 110 are shown solely by way of example. Corresponding further functional units can be connected to the control apparatus 100 and the data traffic generated by these further functional units can be controlled in a corresponding manner using the control apparatus.

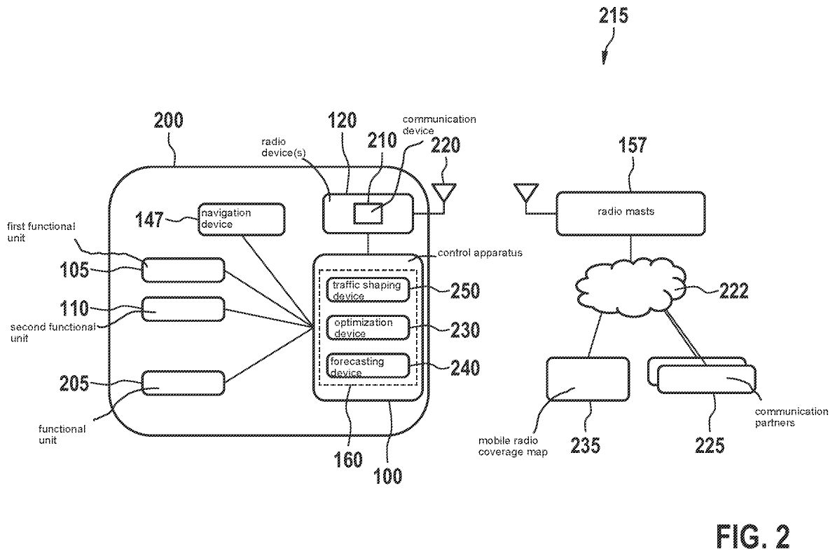

FIG. 2 shows a block diagram of a vehicle system 200 according to an exemplary embodiment. The vehicle system 200 can be used in a vehicle as described in the preceding figure and comprises a control apparatus 100 corresponding or similar to the control apparatus described in the preceding figure.

In addition, the vehicle system 200 comprises a plurality of functional units 105, 110, 205. The functional units 105, 110, 205 are designed to provide requirement signals representing requirements of the functional units 105, 110, 205 in terms of a capacity required in the future for the data traffic for transmitting functional data. Furthermore, the functional units 105, 110, 205 are designed to receive capacity signals representing partial capacities available in the future for the functional units 105, 110, 205. Finally, the functional units 105, 110, 205 are designed to provide functional signals representing the functional data.

In addition, the vehicle system 200 has a radio device 120. The radio device 120 comprises a communication means 210, for example a modem, for transmitting and receiving data via a radio network 215, for example a mobile radio network, and a radio interface 220 for connecting the communication means 210 to the radio network 215. Solely by way of example, the communication means 220 is designed as an LTE modem and can be connected to the internet 222 via a radio mast 157, which can also be referred to as a mobile radio base station. Within the vehicle system 200, the radio device 120 is connected to the control apparatus 100 via the transmission interface 140, wherein the radio device 120 is designed to read in functional signals via the transmission interface 140. At the same time, the control apparatus 100, which can also be referred to as a connectivity control unit (CCU), is designed to be addressed via the LTE modem. All of the data traffic of the vehicle with communication partners 225 outside the vehicle runs via the CCU, for example in order to carry out software uploads or software downloads.

For this purpose, in this exemplary embodiment, the determination device 160 of the control apparatus 100 comprises an optimization device 230 that is designed to use the optional route signal, the network signal, the first requirement signal and the second requirement signal in order to calculate the first partial capacity and the second partial capacity and to assign the partial capacities to the functional units 105, 110, 205. In other words, the optimization device 230, which can also be referred to as an optimizer, receives data about which properties, for example with regard to data rate, latency, etc., the radio connection will have in the future.

The optimization device 230 is designed to compare the probable route of the vehicle with a mobile radio coverage map 235 provided by means of the transmission interface 140 and depicting the radio network coverage in order to determine a temporal progression of the size of the future maximum capacity for the data traffic. Solely by way of example, the mobile radio coverage map 235 is a cloud service that provides predictions of expected connection properties at a location at a particular time. With the help of the most probable path MPP, the expected connection properties along the route of the vehicle can be retrieved. In this exemplary embodiment, the probable route can be determined by means of the navigation device 147. In addition, the optimization device 230 receives all the requirements of the software components for their data flows. On this basis, the optimization device 230 calculates how and when the available resources are to be allocated to the various data flows. In this exemplary embodiment, this allocation can be calculated by optimizing a target function. This target function links to one another, weights and prioritizes the different requirements (utility functions) of the functions. The optimization device 230 is designed to select this target function as desired, wherein the target function can be changed over time in order to express the changing importance and urgency of individual functions. Using the target function, the allocation of resources to data streams can be calculated in different ways. Here, solely by way of example, the optimization device 230 in this exemplary embodiment is designed to use a rigorous mathematical description and subsequent optimal solution by means of linear programming. In another exemplary embodiment, heuristics or approximations can be drawn on additionally or alternatively for the calculation.

By comparing the route with the mobile radio coverage map 235, it is possible to estimate for any point in time in the future what properties, such as maximum data rate, packet loss rate, latency or jitter, the radio transmission from or to the vehicle will have. In another exemplary embodiment, methods such as predictive quality of service (pQos) or a local short-term prediction for the communication channel can be used instead of or in addition to a mobile coverage radio map. With this estimate, together with the communication requirements set by the functional units 105, 110, 205, it is not only possible to carry out an optimal distribution of the communication resources to the individual components, it is also possible to ascertain whether and when the requirements can be fulfilled with a known or unknown probability. In this exemplary embodiment, this information can be provided to the functional units 105, 110, 205 by means of a forecasting device 240 using capacity signals, so that said functional units will already know in advance when their requirements must be adjusted, or when they can expect which properties of the communication. The forecasting device 240, which can also be referred to as a forecast, receives the calculated result of the optimization device 230 and distributes it to those software modules that have placed their requirements. These software modules can deduce the time at which an adjustment of their own data flows is necessary in order to achieve optimal performance. This enables the functional units 105, 110, 205 to initiate measures at an early stage in order to continue operating correctly. Without such an optimal distribution, the system performance will move away from the optimal operating point. In concrete terms, this means that in another exemplary embodiment without the control apparatus described here, either the available capacity is not utilized even though the system would be able to achieve better performance, or an overload is created at the bottleneck, typically at the mobile radio modem. The latter is particularly fatal. This is because overloading the data rate has a negative impact on other channel properties, such as, for example, latency, jitter and packet loss.

In this exemplary embodiment, in addition to the optimization device 230 and the forecasting device 240, the determination device 160 comprises a traffic shaping device 250, which is designed to use the first capacity signal to output the first functional data and use the second capacity signal to output the second functional data via the transmission interface 140. The traffic shaping device 250 can also be referred to as traffic shaping or queue management. The traffic shaping device 250 receives information regarding how the individual data flows are to be treated by the optimizer. By means of traffic shaping, the communication resources of the vehicle can be used in the best possible way (in line with requirements). The actual traffic shaping is outsourced, i.e. it is moved away from the router and to the application or to the communication libraries used therein, such as, solely by way of example, the transport layer protocols QUIC or TCP.

In another exemplary embodiment, the system can also be connected to a plurality of mobile radio networks and WLAN networks simultaneously. In this case, the CCU can have connections to a plurality of LTE modems and additionally or alternatively WLAN cards. As an alternative to the preceding representation in which there is a central component that calculates the optimization and distributes the result to all other components, it can be useful for redundancy reasons if each software component communicates the requirements to every other software component. As a result, each software component can calculate the optimization locally. As an alternative to the preceding representation, in which traffic shaping takes place centrally on the CCU, each software function can have its own traffic shaping, so that functions will not be able to transmit more data to the CCU than defined by the calculated time schedule. This traffic shaping can be implemented directly in the software stack of the transport protocol used, such as, for example, TCP, UDP or QUIC. This would result in significantly less data accumulating on the CCU, since the applications themselves only generate or request as much data as can be exchanged with the mobile radio connection. This also significantly reduces the computing load on the CCU caused by traffic shaping. As an alternative to calculating the time schedule in the vehicle, the time schedule can also be calculated in a component external to the vehicle, for example in the cloud.

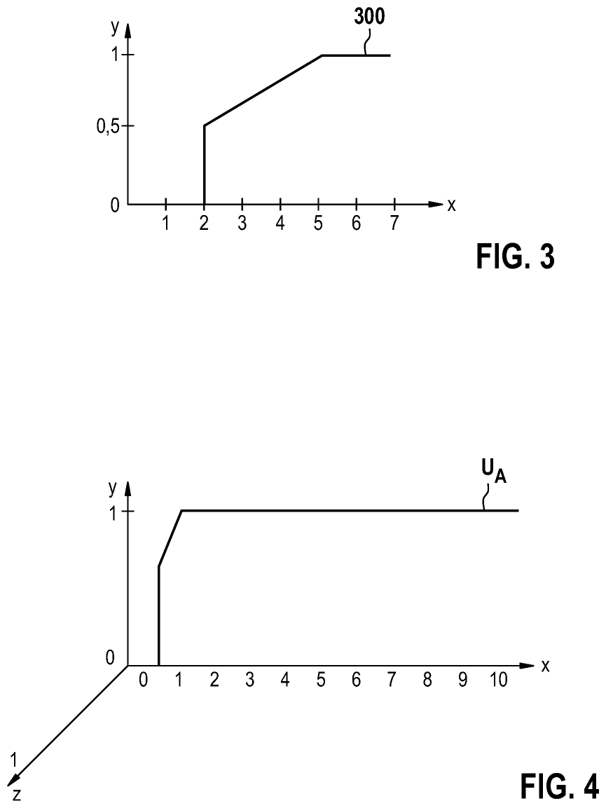

FIG. 3 shows a diagram of an exemplary embodiment of a utility function 300, wherein the data rate is shown on the x-axis in Mbit/s and the utility is shown on the y-axis. Requirements of functional units, as described in the preceding figures, can include utility functions that describe the utility of specific properties for the functional units. The utility function 300 shown here describes that the communication with the external communication partner must be at least 2 Mbit/s in the upload (otherwise the utility is 0) and no additional utility can be derived when more than 5 Mbit/s is available. Between 2 MBit/s and 5 MBit/s, the utility for the function increases linearly. Software functions can use any utility functions to describe the communication requirements. Utility functions can depend not only on the data rate, but also on latency, jitter, packet loss, etc. The utility functions thus become multidimensional. If the utility for a realized communication property is zero, the corresponding requirement is considered not fulfilled.

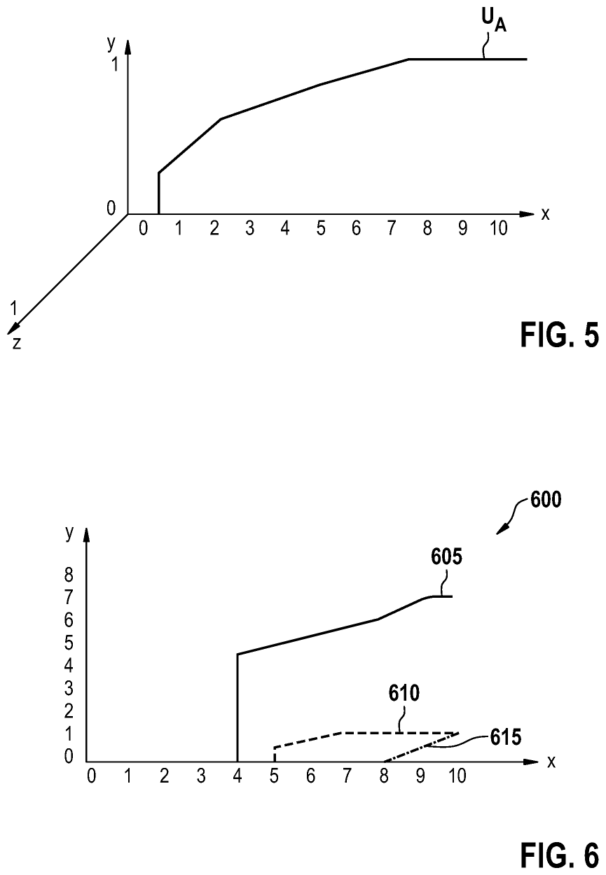

FIG. 4 and FIG. 5 in each case show a diagram of an exemplary embodiment of a multidimensional utility function U_{A} and a further multidimensional utility function U_{B}. In the case of a plurality of competing and independent applications, multidimensional utility functions U_{A}, U_{B} can be used to express the rivalry between these applications. These multidimensional functions have an axis for the utility, which is shown as a y-axis in the illustrations shown here, and an axis for each resource (data rate, latency, error rate, etc.). In the illustrations shown here, the data rate is shown on the x-axis in each case. To model dependencies between applications, an additional axis is introduced in this exemplary embodiment in order to connect two utility functions together. With two applications A and B, the utility function U_{A} of application A now has, solely by way of example, an additional dimension, specifically the utility of application B (U_{B}). As a result, the utility function of application A is dependent on the utility of application B. In the exemplary embodiment shown here, this results in a distributed application that is composed of two parts. Solely by way of example, FIG. 4 describes the utility function U_{A} of a front camera and FIG. 5 describes the utility function U_{B} of a rear camera, both of which require a specific data rate for the distributed application to function. Each sensor requires a specific amount of data rate in order to function properly, wherein the application has a certain utility only when a specific proportion of the data rate is assigned to the individual sensors. In order for the overall application to have a utility of 0.2, for example, at least 4 MBit/s are required for the front video and at least 0.5 MBit/s for the rear video.

In another exemplary embodiment, the front and rear videos can alternatively be linked to one another by using separate and mutually independent two-dimensional utility functions for each sensor U_{front} and Uᵣₑₐᵣ and then, for example, a third utility function for the overall application. The third useful function can be in 3D, with a utility axis, an axis U_{front} and an axis Uᵣₑₐᵣ. However, in this case, a single sensor cannot be of much use, since without the other it is useless. For this reason, these sensor-independent utility functions cannot really be used alone in the optimizer, since their utility is not “genuine.” They are to be connected by the utility function of the overall application.

Since the only resource considered in the exemplary embodiment shown in FIGS. 4 and 5 is the data rate, there is at least one specific assignment of this amount of data rate to the two video sensors for each given amount of data rate, which maximizes the overall utility. Thus, if n MBit/s of resources are used for the application, how these resources can be assigned to the two sensors will be known exactly: Aₙ=(k, l), k+l=n. The definition of these allocations Aₙ for each nϵR⁺ results in a so-called allocation plan. This allocation plan only defines the best assignment of available resources to the various sensors, not the utility for the application that results from this assignment. To express the latter, the application can specify a separate utility function for the entire allocation plan.

FIG. 6 shows a diagram of an allocation plan 600 according to an exemplary embodiment. As soon as a plurality of applications in the sense of a distributed system offer a service whose quality depends on the utility of its individual components, the (manual) definition of the corresponding utility functions will be highly time-consuming. It is therefore also possible to generate such dependent utility functions from an allocation plan. An allocation plan for a distributed system specifies how resources need to be distributed to individual data streams so that the distributed system can provide a certain utility as a whole. Such a plan can be seen by way of example in the illustration shown here for three different data streams. This is, solely by way of example, an allocation plan 600 for three sensors 605, 610, 615, or the allocation of the available data rate to three data streams. The plan comprises three different sensors and defines how much data rate is assigned to each sensor (y-axis) for a given amount of data rate available to the application (x-axis). For example, if the application receives a total of 4 Mbit/s data rate, all 4 Mbit/s will be assigned to the first sensor 605. However, if the application receives 5 Mbit/s, solely by way of example, 4.5 Mbit/s will be assigned to the first sensor 605 and 0.5 Mbit/s to the second sensor 610, for example. In the figure shown here, only the data rate available is shown, but the same principle can also be applied in a multidimensional case, for example with data rate, latency and bit error rate.

In other words, the use of allocation plans can also be described as follows. In general, allocation plans solve the problem of allocating available resources to a known amount of data-generating units, for example sensors or data storage devices. However, they cannot be used if not all consumers are known in advance, i.e. in a system in which a plurality of different applications are used that do not originate from the same developers, or if new applications come and go in the course of time. Utility functions can be generated from an allocation plan. In an exemplary embodiment, it is possible to start by defining an allocation plan for two sensors, for example, and the resulting utility function for an application. After this, linear utility functions can be created separately for each sensor by assigning an artificial utility to each assigned data rate. For example, the utility of an assigned data rate can be defined by the assigned data rate itself, divided by the maximum assigned data rate for this particular sensor.

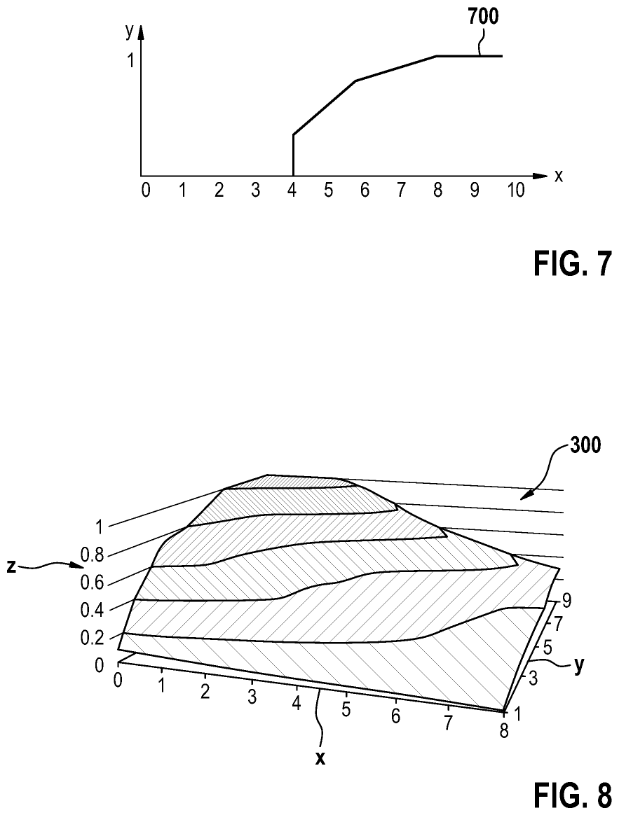

FIG. 7 shows a diagram of another utility function 700 according to an exemplary embodiment. The other utility function 700 shown here can be defined solely by way of example for an allocation plan, as described in the preceding FIG. 6, and indicates the utility of the distributed system. The utility is shown on the y-axis and the data rate on the x-axis.

FIG. 8 shows a diagram of an exemplary embodiment of a utility function 300. The utility function 300 shown here corresponds to or is similar to the utility function described in the preceding FIG. 3, with the difference that the utility function 300 shown here is shown in three dimensions solely by way of example. The utility is shown on the z-axis, the packet error rate on the x-axis and the data rate on the y-axis. In further exemplary embodiments, the dimensions used and their quantity can be arbitrary. These can be used to map the utilities experienced by the application from the communication. For example, video and audio codecs can allow video and audio to be encoded at different data rates. As a rule, the lower the data rate, the lower the quality or utility of the video. However, this relationship is by no means linear. Moreover, some codecs can contain redundancies, so that they can handle packet loss. However, here as well, packet loss can result in a loss of audio or video quality. However, a video telephony application can have a plurality of codecs or a plurality of configurations of the same codec, which in each case can handle different communication conditions and can be changed during runtime. The resulting utility function can be highly application-specific and can also depend on which of the available codecs are also supported by the other terminal. Meaningful optimization of the allocation of communication resources to applications cannot be effected without knowledge of this utility function.

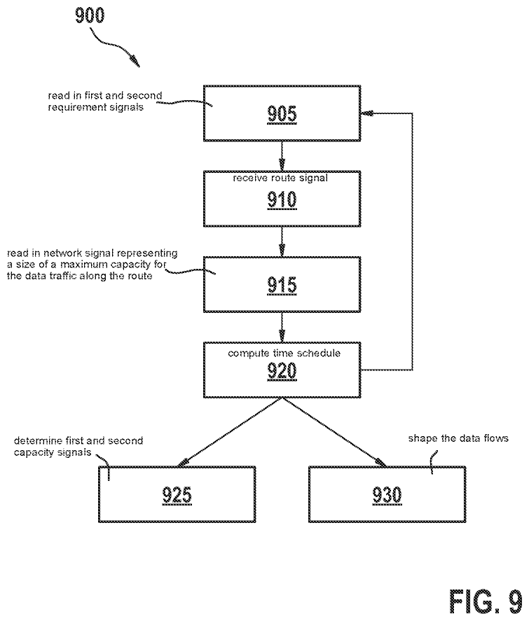

FIG. 9 shows a flow chart of a method 900 for controlling data traffic according to an exemplary embodiment. Solely by way of example, this is an iterative method that runs in a plurality of steps 905, 910, 915, 920, 925, 930.

In a first step 905 of reading in, a first requirement signal and a second requirement signal are read in via a functional interface to a first functional unit and to a second functional unit. The first requirement signal represents a first requirement of the first functional unit in terms of a capacity required in the future for the data traffic for transmitting first functional data and the second requirement signal represents a second requirement of the second functional unit in terms of a capacity required in the future for the data traffic for transmitting second functional data. In other words, in this step 905 requirements for the communication properties of the software functions are collected. In this exemplary embodiment, these requirements consist of deadlines and utility functions. It is not only the functions within the vehicle but also the communication partners outside the vehicle in which the control apparatus is operated that can place requirements.

In one exemplary embodiment, the step 905 of reading in is followed by an optional step 910 of receiving a route signal. The probable future path or the current MPP is received. This describes the path along which the vehicle will travel in the future.

Only optionally, the method 900 furthermore comprises a step 915 of reading in a network signal representing a size of a maximum capacity for the data traffic along the route and dependent on a radio network coverage. In this exemplary embodiment, in this step 915, a mobile radio coverage map along the MPP is requested. The mobile radio coverage map accordingly provides a forecast of which communication properties, i.e. which available data rate, latency, packet error rate, jitter, etc., can be expected at each point of the MPP.

In this exemplary embodiment, a step 920 of calculation follows, in which a time schedule is computed indicating which software function is allowed to transmit or receive how much data over a modem, for example, an LTE modem, at what time. This time schedule is calculated solely by way of example in such a way that the target function selected by an optimization device of the control apparatus is maximized. In this exemplary embodiment, the time schedule is found by means of mathematical optimization. After the step 920 of calculation, the control apparatus in this exemplary embodiment recommences with the step 905 of reading in the first and second requirement signals. Solely by way of example, the step 925 of determination and an exemplary step 930 of shaping are carried out simultaneously.

In the step 925 of determination, a first capacity signal and a second capacity signal are determined. The determination is carried out using the optional route signal, the network signal, the first requirement signal and the second requirement signal. The first capacity signal represents a first partial capacity available in the future for the first functional unit and the second capacity signal represents a second partial capacity available in the future for the second functional unit, in order to make it possible for the functional units to adjust the capacities required in the future to the partial capacities available in the future. In other words, in this step 925, each software component that has placed requirements is informed of the time at which it can expect which communication properties.

In the step 930 of shaping, in this exemplary embodiment, a traffic shaping device of the control apparatus is instructed to shape the data flows according to the calculated time schedule. In this exemplary embodiment, there is, solely by way of example, a so-called legacy software in the vehicle. If the legacy application generates a lot of data that cannot be transported due to a shortage of resources, the generated data will be discarded by the traffic shaping.

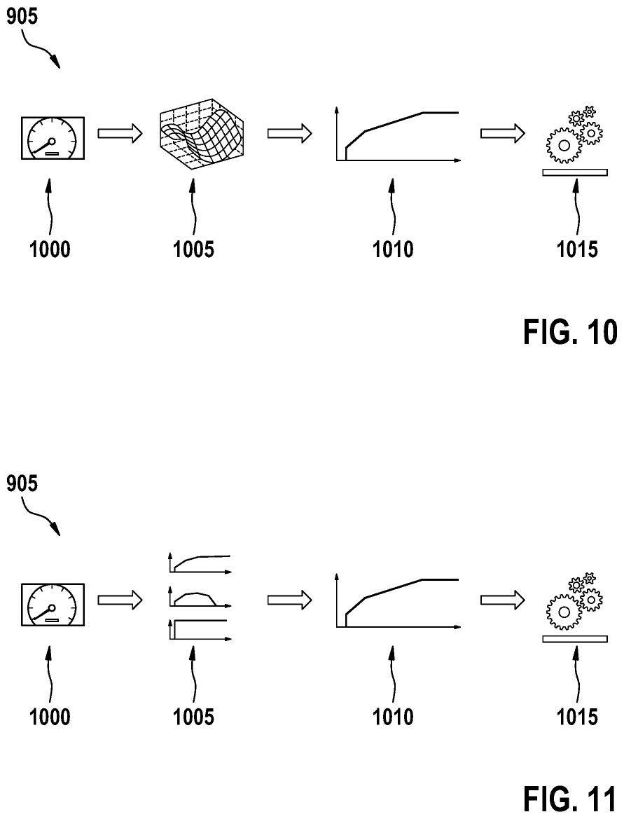

FIG. 10 shows a flow chart of an exemplary embodiment of a step 905 of the method 900 for controlling data traffic. The step 905 described here corresponds to or is similar to the step of reading in a requirement signal as described in the preceding FIG. 9. The step 905 of reading-in shown here is divided into four sub-steps. In the first sub-step 1000, the parameters of an sensor inside the vehicle are determined. In the second sub-step 1005, an internal, multidimensional utility function is determined from the parameters. In the third sub-step 1010, a specific requirement of a functional unit is created in terms of a capacity required in the future for the data traffic for the transmission of functional data. In the fourth sub-step 1015, this requirement is read in in the form of a requirement signal by a determination device of the control apparatus and a partial capacity corresponding to the requirement is calculated by an optimization device of the determination device. In this exemplary embodiment, the internal utility functions have higher dimensions, wherein some of these dimensions are so-called internal parameters, which are, solely by way of example, the current driving speed and the distance to the nearest object. Such internal utility functions are used to derive the actual utility functions that are passed on to the central optimizer of the network system.

FIG. 10 shows a flow chart of an exemplary embodiment of a step 905 of the method 900 for controlling data traffic. The step 905 described here corresponds to or is similar to the step of reading in a requirement signal as described in the preceding FIGS. 9 and 10 and is subdivided into four sub-steps 1000, 1005, 1010, 1015 congruently with the sequence described in the preceding FIG. 10. In this exemplary embodiment, the internal utility function comprises three dimensions, of which one is the vehicle state. Since the vehicle state is an internal parameter of the vehicle and outside the domain for the participatory network, the current vehicle speed is used to extract a two-dimensional utility function consisting of the axes of utility and data rate, which is then passed on to the central optimizer. Each time the vehicle speed changes, the vehicle transmits an updated utility function to the optimizer. In other exemplary embodiments, any n-dimensional internal utility functions and m-dimensional utility functions (where n>=m) can be used. In order to avoid transmitting constantly updated utility functions to the optimizer, the application should only do this when the update of the utility function is significant.

1-15. (canceled)

16. A control apparatus for controlling data traffic generated by functional units of a vehicle via a radio device of the vehicle, the control apparatus comprising:
a functional interface configured to connect the control apparatus to a first functional unit of the functional units and a second functional unit of the functional units, and to read in a first requirement signal representing a first requirement of the first functional unit in terms of a capacity required in the future for data traffic for transmitting first functional data, and a second requirement signal representing a second requirement of the second functional unit in terms of a capacity required in the future for data traffic for transmitting second functional data;
a transmission interface configured to connect the control apparatus to the radio device; and
a determination device configured to use a network signal, which represents a size of a maximum capacity for data traffic along a probable future route of the vehicle and dependent on a radio network coverage, to determine a first capacity signal of the first requirement signal and the second requirement signal, which represents a first partial capacity available in the future for the first functional unit, and to determine a second capacity signal representing a second partial capacity available in the future for the second functional unit, in order to make it possible for the first and second functional units to adjust the capacities required in the future to the first and second partial capacities available in the future.

17. The control apparatus according to claim 16, wherein the determination device is configured to use a route signal representing the probable future route of the vehicle in order to determine the first capacity signal and the second capacity signal.

18. The control apparatus according to claim 16, wherein the determination device is configured to calculate an allocation of the first and second partial capacities for the data traffic to the first and second functional units and to provide the first and second capacity signals to the first and second functional units via the functional interface.

19. The control apparatus according to claim 17, wherein the determination device is configured to read in the route signal via the functional interface.

20. The control apparatus according to claim 16, wherein the determination device is configured to read in the network signal via the transmission interface.

21. The control apparatus according to claim 17, wherein the determination device includes an optimization device, which is configured to use the route signal, the network signal, the first requirement signal, and the second requirement signal to calculate the first partial capacity and the second partial capacity and to assign the first and second partial capacities to the first and second functional units.

22. The control apparatus according to claim 21, wherein the optimization device is configured to compare the route with a mobile radio coverage map provided using the transmission interface and depicting the radio network coverage, in order to determine a temporal progression of a size of a future maximum capacity for the data traffic.

23. The control apparatus according to claim 16, wherein the determination device includes a forecasting device, which is configured to provide the first and second capacity signals.

24. The control apparatus according to claim 16, wherein the determination device is configured to read in a first functional signal including the first functional data and a second functional signal including the second functional data via the functional interface and to provide the first and second functional signals to the transmission interface.

25. The control apparatus according to claim 16, wherein the determination device includes a traffic shaping device, which is configured to use the first capacity signal to output the first functional data and use the second capacity signal to output the second functional data via the transmission interface.

26. The control apparatus according to claim 16, wherein the first requirement and/or the second requirement includes a utility function, wherein the utility function describes the utility of specific properties of the data traffic for transmitting the first and/or second functional data.

27. The control apparatus according to claim 26, wherein the utility function can be determined using an allocation plan.

28. The control apparatus according to claim 16, wherein the first requirement and/or the second requirement includes an expiration period for defining an end point in time of the transmission of the first and/or second functional data.

29. A vehicle system of a vehicle, comprising:
a control apparatus configured to control data traffic generated by a plurality of functional units of the vehicle via a radio device of the vehicle;
the plurality of functional units, which are configured to provide requirement signals representing requirements of the functional units in terms of a capacity required in the future for the data traffic for transmitting functional data, to receive capacity signals representing partial capacities available in the future for the functional units, and to provide functional signals representing the functional data; and
the radio device, which has at least one communication device for transmitting and receiving data via a radio network, a radio interface for connecting the communication device to the radio network and a transmission interface for connecting the radio device to the control apparatus, wherein the radio device is configured to read in the functional signals via the transmission interface.

30. The vehicle system according to claim 29, wherein the control apparatus includes:
a functional interface configured to connect the control apparatus to a first functional unit of the functional units and a second functional unit of the functional units, and to read in a first requirement signal representing a first requirement of the first functional unit in terms of a capacity required in the future for data traffic for transmitting first functional data, and a second requirement signal representing a second requirement of the second functional unit in terms of a capacity required in the future for data traffic for transmitting second functional data;
a transmission interface configured to connect the control apparatus to the radio device; and
a determination device configured to use a network signal, which represents a size of a maximum capacity for data traffic along a probable future route of the vehicle and dependent on a radio network coverage, to determine a first capacity signal of the first requirement signal and the second requirement signal, which represents a first partial capacity available in the future for the first functional unit, and to determine a second capacity signal representing a second partial capacity available in the future for the second functional unit, in order to make it possible for the first and second functional units to adjust the capacities required in the future to the first and second partial capacities available in the future.

31. A method for controlling data traffic generated by functional units of a vehicle via a radio device of the vehicle, wherein the method comprises the following steps:
reading in a first requirement signal and a second requirement signal via a functional interface to a first functional unit and a second functional unit, wherein the first requirement signal represents a first requirement of the first functional unit in terms of a capacity required in the future for the data traffic for transmitting first functional data and the second requirement signal represents a second requirement of the second functional unit in terms of a capacity required in the future for the data traffic for transmitting second functional data; and
determining a first capacity signal and a second capacity signal using a network signal representing a size of a maximum capacity for the data traffic along a probable future route of the vehicle and dependent on a radio network coverage, the first requirement signal and the second requirement signal, wherein the first capacity signal represents a first partial capacity available in the future for the first functional unit, and wherein the second capacity signal represents a second partial capacity available in the future for the second functional unit, in order to enable the first and second functional units to adjust the capacities required in the future to the partial capacities available in the future.
